(19) United States
(12) Patent Application Publication
(10) Pub. No.: US 2022/0409348 A1
(43) Pub. Date: Dec. 29, 2022

(54) METHOD FOR DEFINING AT LEAST ONE BOUNDARY SURFACE INSIDE AN ARTIFICIAL TOOTH ELEMENT

(71) Applicant: VITA ZAHNFABRIK H. RAUTER GMBH & CO. KG, Bad Säckingen (DE)

(72) Inventors: Armin Kirsten, Bad Säckingen (DE); Annika Vahle, Bad Säckingen (DE)

(73) Assignee: VITA ZAHNFABRIK H. RAUTER GMBH & CO. KG, Bad Säckingen (DE)

(21) Appl. No.: 17/778,075

(22) PCT Filed: Dec. 3, 2020
(86) PCT No.: PCT/EP2020/084370

§ 371 Date: May 19, 2022

(30) Foreign Application Priority Data
Dec. 18, 2019 (EP) 19217393.8

(51) Int. Cl. A61C 13/00; G06T 19/20

(52) U.S. Cl. CPC A61C 13/0004; G06T 19/20; G06T 2207/30036

(57) ABSTRACT

A method for defining at least one boundary surface inside an artificial tooth element, the method comprising the steps of: aligning the tooth element with a coordinate system which preferably relates to anatomically defined directional terms; defining a first boundary curve on the tooth surface; determining a tooth surface located incisally/occlusally with respect to the first boundary curve; and moving this tooth surface inwards in the direction of the surface normal by different amounts in order to produce the at least one boundary surface, in particular the first boundary surface, wherein the different amounts of the movement involve variable design parameters.

### BACKGROUND

### 1. Field of the Disclosure

The disclosure relates to a method for defining at least one boundary surface inside an artificial tooth element.

### 2. Discussion of the Background Art

A substantial aim of manufacturing artificial tooth elements is for the artificial tooth element to be as similar as possible in appearance to the patient's natural teeth. In the natural tooth, the dentin is surrounded by tooth enamel in the visible area.

For manufacturing tooth elements, which may be a complete artificial tooth, a crown or the like, it is known to manufacture the tooth element also from at least two different materials and to reproduce the boundary between dentin and tooth enamel. For this purpose, it is known from DE 10 2010 002 484 A1 to determine the boundary between dentin and enamel on the patient's natural tooth by means of an X-ray method and then to manufacture a tooth element in which an inner material reproducing the dentin has the same geometric shape as the patient's natural dentin and, in particular, to form the layer thickness of the material replacing the tooth enamel in accordance with the thickness of the natural tooth enamel. Since the materials replacing the tooth enamel and the dentin in an artificial tooth element do not have the same optical properties as the natural materials, artificial tooth elements manufactured in such a way differ in their optical appearance from the appearance of the patient's other teeth.

From WO 2004/037112, the configuration of prefabricated teeth is known. These are teeth which are manufactured in a large number (mass-produced goods). Such pre-fabricated teeth can only be adapted to a patient's dental situation to a limited extent by machining the outer contours. The optical appearance cannot be changed to the desired extent if the outer contour remains unchanged.

An object of the disclosure is to provide a method for defining a boundary surface inside an artificial tooth element, wherein an artificial tooth element with satisfactory optical properties can be manufactured with the aid of such a method, wherein the optical properties of the artificial tooth element correspond as far as possible to the optical properties of the patient's natural tooth or come as close as possible.

### SUMMARY

With the aid of the method according to the disclosure, the at least one boundary surface inside a digital tooth data model of an artificial tooth element is defined. The at least one boundary surface is a boundary surface between at least two different materials out of which the artificial tooth element is manufactured. Said boundary surface does not correspond or at least does not completely correspond to the boundary surface between dentin and tooth enamel of the patient's natural tooth and is not defined taking into account the actual boundary, respectively. By defining at least one other boundary surface, i.e. one that differs at least partially from the natural boundary surface, the optical properties of the materials used are utilized in such a way that the optical appearance of an artificial tooth element manufactured in such a way comes as close as possible and preferably substantially corresponds to the optical appearance of the natural tooth. According to the disclosure, such an exact and detailed adjustment of the optical appearance of an artificial tooth element to the optical appearance of the natural tooth element is preferably always carried out by means of the digital tooth data model, as this makes it possible to individually adjust the boundary surface between dentin and tooth enamel.

First, the three-dimensional outer contour of the tooth element can be determined. Here, the outer contour of the artificial tooth element corresponds to the outer contour of the natural tooth to be replaced. This can be done, for example, by selecting a suitable outer contour from a tooth library which is individually adjusted to the anatomy in order to satisfy the functional and esthetic requirements of the restoration to be made. As an alternative to selecting the shape from a tooth library, the tooth contour of the opposite tooth can also be mirrored for a single crown, for example. In a step preceding the method according to the disclosure, in particular, a three-dimensional outer contour of a tooth element can be determined and, in particular, recorded. It is also possible to open a data set that includes the three-dimensional outer contour of the tooth element.

Furthermore, in preparation for the method according to the disclosure, a three-dimensional outer contour of the tooth element can be aligned with a coordinate system. The coordinate system preferably relates to anatomically defined directional terms, so that the coordinate system has in particular the mesial, distal, apical and incisal/occlusal directions. Aligning the tooth element with a coordinate system has the advantage that it is possible in a simple manner to define at least one boundary surface inside the tooth element, from the three-dimensional outer contour of the tooth element.

According to the disclosure, a first boundary curve is defined on the tooth surface of the artificial tooth element. A first boundary curve can be defined based on the tooth equator. The tooth equator is the largest circumference of a tooth in the area of the dental crown. The first boundary curve can also be based on a preparation boundary as a curve, the preparation boundary being the boundary between the artificially machined tooth element and the unmachined tooth surface. It is also possible to define the first boundary curve at least partially manually. It is also possible to manually adjust a curve defined, in particular automatically, based on the tooth equator and/or the preparation boundary, for example. It is preferred that the first boundary curve is defined between the tooth equator and the preparation boundary. Here, it is possible, for example, to define the first boundary curve at a fixed distance to the tooth equator and/or to the preparation boundary. In particular, the first boundary curve can have the same distance to the tooth equator and to the preparation boundary, i.e. be provided exactly between the tooth equator and the preparation boundary.

With respect to the first boundary curve, an incisally/occlusally located tooth surface is determined. According to the disclosure, said tooth surface is displaced inwards. The displacement takes place in the direction of the surface normal, wherein the displacement takes place in particular by different amounts. Thus, there are surface areas of the tooth surface that are displaced inwards to a greater or lesser extent. These different amounts of displacement are based on variable design parameters. Such displacement of the tooth surface produces the at least one boundary surface.

Due to the in particular three-dimensional complex shape of the tooth surface and thus also the in particular first boundary surface produced by displacement, a displacement takes place in the direction of the different surface normals. The surface normals point in different directions because the tooth surface is a three-dimensional surface.

It is particularly preferred to divide the tooth surface into several, in particular a plurality of partial surfaces. It is particularly preferred to provide at least 30 partial surfaces. Preferably, the individual partial surfaces are then displaced towards an associated surface normal by different amounts in order to produce the at least one, in particular the first boundary surface. Here, the reduced partial surfaces are in particular automatically displaced to form a, in particular, closed boundary surface, i.e. a boundary surface forming a surface without gaps. Here, the individual partial surfaces can have a triangular outer contour in particular.

The design parameters may vary, in particular if the patient has different teeth. Different design parameters may also be required, for example, if the restoration is performed on differently colored tooth stumps or if the restorations are designed with different thicknesses, since the optical appearance of the tooth stumps has an influence on the appearance of the artificial tooth element due to the translucency of the materials used. In particular, the design parameters also depend on the material used. For example, a minimum wall thickness of a material can be predetermined.

This is particularly the case with the inner, in particular dentin-colored material, which substantially determines the stability. In addition, the optical properties of a polymer-based material differ from those of purely ceramic materials.

In a preferred further embodiment of the method according to the disclosure, the variable design parameter describe a maximum first displacement of the tooth surface and/or a first length for defining a transition surface.

Preferably, the first displacement is selected such that there is no displacement yet for anterior and posterior teeth directly at the first boundary curve. For posterior teeth, there is also no displacement at the central fissure. The amount of the first displacement then preferably increases steadily in the direction of the surface normal towards incisal or occlusal, from the first boundary curve, until the amount of the displacement reaches the maximum first displacement.

The transition surface can be defined, for example, by specifying the design parameter of the first length. Preferably, the first length thus defines, from the first boundary curve, a transition area, the transition surface preferably extending in incisal/occlusal direction. The transition surface is defined from zero up to the full first displacement. A transition area is provided in order to realize a, in particular, fluent transition from the first boundary curve up to the full first displacement. By defining such a transition surface, it is possible to reproduce the natural appearance of a tooth in which the tooth enamel becomes increasingly thinner in the apical direction.

A transition surface can also be defined such that the first boundary curve is projected incisally or occlusally by the first length, with a second boundary curve being defined by this projection. The transition surface is then defined between the first and the second boundary curve.

The design parameter of the first length for defining the transition surface is preferably smaller than the maximum height of the tooth element, from the first boundary curve. Preferably, the first length is smaller than 80%, particularly preferred smaller than 50%, of said maximum height.

In a preferred further embodiment of the method according to the disclosure, the variable design parameters describe a further v of the first boundary surface. By the preferred further development of the method according to the disclosure in such a way that the first boundary surface is displaced, a tooth element can be produced, the appearance of which is even closer to the natural appearance of the tooth. In particular, this further displacement can avoid sharp edges that might otherwise be visible. This further v imitates irregularities in the natural layer structure of a tooth (so-called mamelons).

First, a third or further boundary curve is defined or produced, respectively. This is done by projecting the first or second boundary curve by a second length, wherein providing a second boundary curve is optional. In particular, the third or further boundary curve is produced by incisal or occlusal projection of the first boundary curve or by apical projections of the second boundary curve. Alternatively, the third boundary curve can be produced, independent of the first or second boundary curve, manually or based on other features of the tooth element, for example the equator or the preparation boundary.

Furthermore, preferably an incisal or occlusal first surface contour is determined. The first surface contour is defined by the highest curve on the first boundary surface produced by the first maximum displacement. The highest curve can be determined automatically and corrected manually, if necessary. Node points are produced or specified on the first surface contour. Then, the node points are at least partially displaced in apical or incisal/occlusal direction. The at least partially displaced node points are connected to each other with a second surface contour. The second surface contour produced in such a way defines the maximum second displacement of the tooth surface (or of the first boundary surface) in the area of the incisal or occlusal surface contour.

In this preferred embodiment of the method according to the disclosure, the amount of the second displacement decreases steadily in the direction of the surface normal for anterior and posterior teeth in apical direction by a third length until at most the third boundary curve or a length defined as maximum for this purpose is reached, respectively. For posterior teeth, the amount of the second displacement also decreases steadily in the direction of the central fissure until the central fissure is reached. Preferably, the amount of the second displacement directly at the third boundary curve or directly at the central fissure is zero. Th central fissure can also be defined manually and/or an automatically defined or predefined cent central er fissure can be corrected manually.

Preferably, the maximum first displacement of the tooth surface is in the range from 0 to 4 mm.

Moreover, it is preferred that the first length, which is required for producing the transition surface, has an extension of 0.1 mm to 10 mm.

A boundary, i.e. the beginning and end of the automatically determined highest curve on the first and/or second incisal surface contour, is defined in a preferred further embodiment of the disclosure for anterior teeth by an angle. The angle is an angle between the tangent on the incisal surface contour and the tooth axis, the angle being preferably 0° to 90°, preferably 10° to 70°, and particularly preferably 40° to 50°. For teeth, the tooth axis is defined as the connecting line between the root tip for single-rooted teeth and the center of the incisal edge or chewing surface, respectively, and for multi-rooted teeth between the root bifurcation and the center of the chewing surface. In particular, it is also possible to manually define or adjust the boundary, i.e. the beginning and the end, as well as the course of the incisal surface contour.

Preferably, the position of the node points on the incisal surface contour of anterior teeth is specified or defined relative to the total length of the incisal surface contour.

Here, it is preferred that at least five points are defined on the incisal surface contour. Is it preferred to define a higher number of points, in particular more than 10 and particularly preferred more than 20 points.

For posterior teeth, it is preferred that the positions of the node points on the incisal/occlusal surface contour are specified per cusps relative to the lengths of the cusp ridges. In particular, the length of the cusp ridges between the mesial cusp start and the cusp tip or the cusp tip and the distal cusp end, respectively, is used here. It is in turn preferred that at least five points are defined per cusp on the total length of the occlusal surface contour. A higher number of points of at least 10, in particular at least 20 points, is preferred.

The displacement of the node points on the incisal/occlusal surface contour in apical direction is preferably in the range of −4.0 mm to +4.0 mm.

The tooth element can be aligned manually.

It is preferred that the tooth element is aligned automatically with respect to anatomically defined directional terms by geometric analysis of the tooth elements and their comparison to reference geometries. For example, as compared to the incisal/occlusal direction for dental crowns, the apical direction can be determined by automatically detecting a preparation boundary by means of a defined boundary angle of the surface geometry of the tooth element. With respect to the remaining tooth element, the preparation boundary points in the apical direction, which also corresponds to the tooth axis. In order to automatically determine the correct rotation of the tooth element about said tooth axis, the cusp tips of the tooth element can be detected as the highest occlusal/incisal points, which can be aligned by means of curvature and angle features in connection with the central fissure which is the most apical line of the occlusal surface. For anterior teeth, the incisal edge can be used as the silhouette curve located at the far incisal end to determine the correct alignment towards mesial and distal by means of the curvature and angle feature.

Furthermore, it is preferred that the alignment of the tooth element is based on metadata which are generated when producing the outer contour. Depending on the CAD program used to produce the outer contour, for example, the geometry data of the tooth element could be aligned with respect to an xzy coordinate system, which, for example, always defines incisal in the z-direction, labial always in the y-direction, or similar. The information are partially output as XML data. Based on said information, an alignment for the here described method can then be performed automatically.

As described above, the first boundary curve can be based on the detection of the tooth equator. Here, it is preferred that at least four node points are described on this curve according to the anatomically defined directional terms, the node points being displaced in the apical or incisal/occlusal direction by distances defined relative to the tooth size on the tooth surface. The first boundary curve can, for example, be produced very well by displacing the tooth equator at the at least four node points in the apical direction by half the distance between the tooth equator and the preparation boundary.

As described, the first boundary curve can also be based on the detection of the preparation boundary. On this curve, it is also preferred that at least four node points are described according to the anatomically defined directional terms, the node points being displaced in apical or incisal/occlusal direction by distances defined relative to the tooth size on the tooth surface.

The central fissure can be determined automatically for posterior teeth by detecting or determining the deepest curve on the occlusal surface leading from mesial to distal. Such a determined central fissure might be adjusted manually. The central fissure can also be marked manually. Marking or determining can be performed, for example, with imaging methods, since the central fissure is the deepest curve in the incisal/applical direction.

According to the disclosure, the at least one boundary surface defined inside the artificial tooth element thus preferably serves for defining the spatial expansion of different materials in the tooth element. Here, the different materials in particular have different optical properties. Due to the defined spatial expansion, the materials with different optical properties give the artificial tooth element a natural appearance in which the materials imitate preferably at least the optical properties of dentin or tooth enamel, respectively. Different materials can also have different mechanical properties.

Opening a data set of the digital tooth data model is optional and only required if corresponding data has been saved before. If a restoration is performed directly after collecting the data, it is not required to open a stored data set.

The artificial tooth element according to the disclosure preferably imitates an individual tooth which is manufactured as part of or in the form of a dental restoration. Here, the dental restoration preferably includes a tooth- or implant-borne crown, bridge or removable full or partial denture.

With the aid of the method according to the disclosure, it is particularly possible, by the boundary surface inside the artificial tooth element, to also define the spatial expansion of different materials used in the tooth element. Here, it is particularly possible that the different materials have different optical properties. By specifying the spatial expansion of the individual materials in the artificial tooth element, in particular according to the disclosure, an appearance very close to the natural appearance of the tooth can be achieved.

The different materials used can also have different mechanical properties.

In particular, the tooth element according to the disclosure is a dental restoration. It can be a tooth- or implant-borne crown, bridge or also a removable full or partial denture.

### BRIEF DESCRIPTION OF THE DRAWINGS

In the following, the disclosure is described in more detail by means of a preferred embodiment with reference to the accompanying drawings, in which:

FIG. 1 shows a schematic front view of an artificial tooth element of an anterior tooth,

FIG. 2 shows a schematic side view of an artificial tooth element of an anterior tooth,

FIGS. 3 and 4 show a schematic front view and side view, respectively, of an artificial tooth element of an anterior tooth according to FIGS. 1 and 2, wherein additional surfaces and curves are illustrated,

FIGS. 5 and 6 show a schematic front view and side view, respectively, of an artificial tooth element of an anterior tooth according to FIGS. 1 and 2, wherein additional surfaces and curves are illustrated,

FIG. 7 shows an incisal view of the tooth element shown in FIG. 5,

FIGS. 8a to 8c show an alternative illustration of FIG. 5 with different tangential angles,

FIG. 9 shows a schematic illustration of a first and a second surface contour,

FIG. 10 shows a schematic front view of a tooth element of an anterior tooth according to FIGS. 1 and 2, wherein additional surfaces and curves are illustrated,

FIG. 11 shows a schematic side view along the section plane XI in FIG. 10,

FIG. 12 shows a schematic side view of an artificial tooth element of a posterior tooth, and

FIG. 13 shows a schematic view from incisal of the artificial tooth element of a posterior tooth shown in FIG. 12.

### DETAILED DESCRIPTION OF THE PREFERRED EMBODIMENT

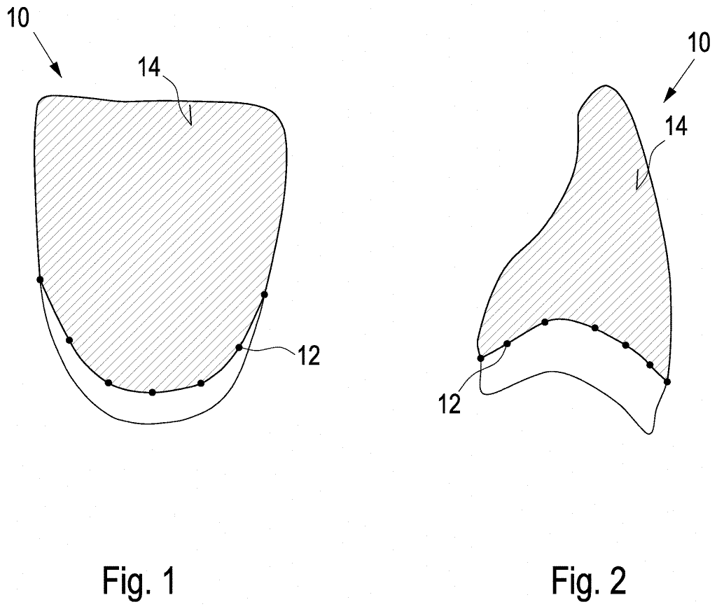

FIGS. 1 and 2 show an artificial tooth element 10 of an anterior tooth in front and side view. This is a three-dimensional outer contour of the tooth element, wherein preferably a corresponding data set has been opened which includes the data of the three-dimensional outer contour of the tooth element. After aligning the tooth element 10 with a (non-illustrated) coordinate system, a first boundary curve 12 is defined, wherein the first boundary curve 12 can be defined manually and/or based on a preparation boundary or based on a tooth equator. In incisal direction, i.e. in FIGS. 1 and 2 above the first boundary curve 12, a tooth surface 14 is defined by the first boundary curve 12.

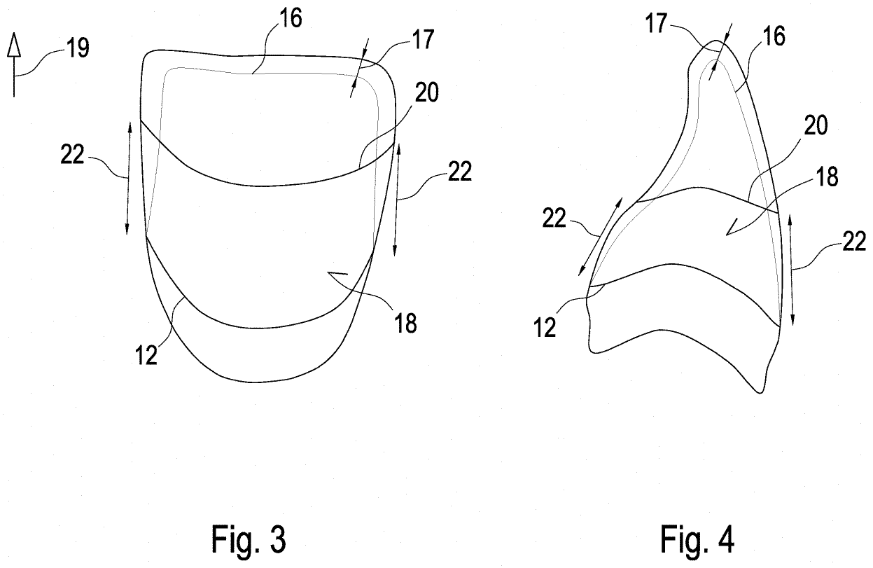

The tooth surface 14 is displaced inwards in the direction of the surface normal in order to produce a first boundary surface 16 (FIGS. 3 and 4). Here, a maximum displacement 17 is exemplarily illustrated.

As shown in FIGS. 3 and 4, by means of a preferred embodiment of the disclosure, a transition surface 18 extending in incisal direction 19 can be defined from the first boundary curve 12. In the illustrated exemplary embodiment, the transition surface 18 is defined in such a way that a second boundary curve 20 is defined. The second boundary curve 20 can be defined by a projection of the first boundary curve 12 by a first length 22.

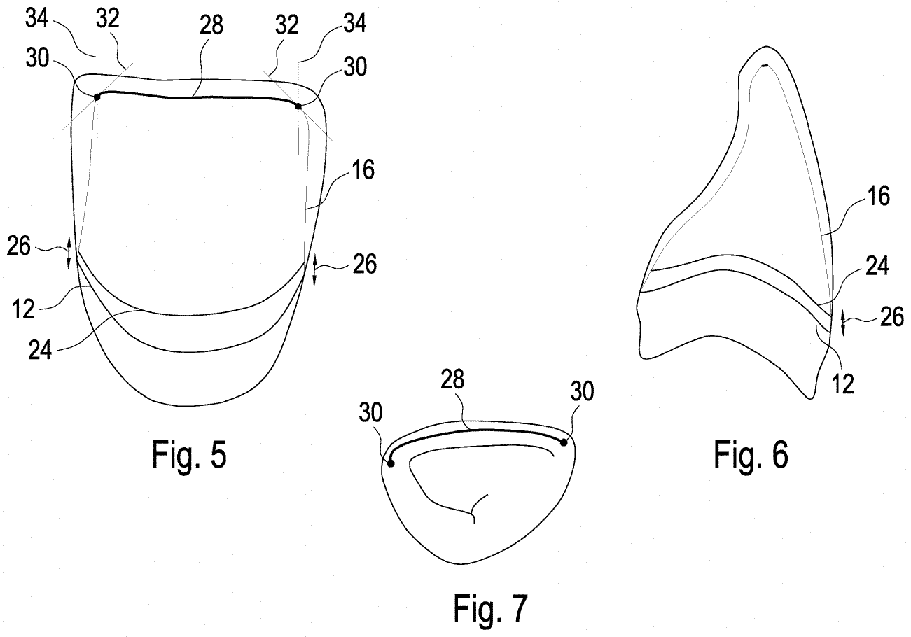

In the illustrated exemplary embodiment, a third boundary curve 24 (FIGS. 5 and 6) is also defined. The third boundary curve 24 can be defined by projection of the first boundary curve 12 by a second length 26.

The highest curve on the first boundary surface 16 produced by the first maximum displacement is defined as incisal/occlusal first surface contour 28. The first surface contour 28 has two boundaries 30 or, in particular, a beginning and an end, respectively. Here, the boundaries 30 are defined by tangents 32. In FIG. 5, the tangents 32 have an angle of approx. 45° to the tooth axis 34.

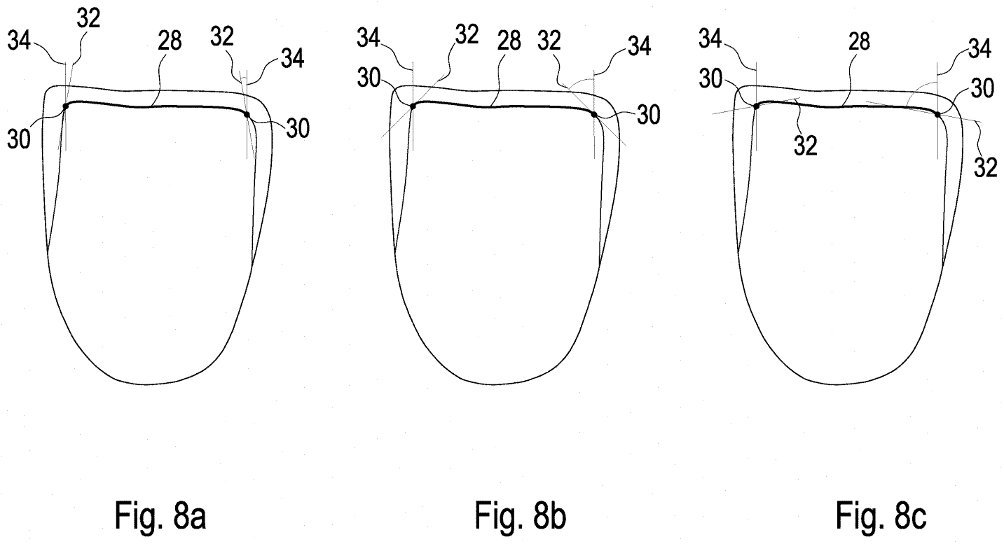

As shown in FIGS. 8a to 8c, the position of the boundaries 30 changes when the tangential angel changes.

The course of the first surface contour 28 is shown in plan view or in incisal view (FIG. 7).

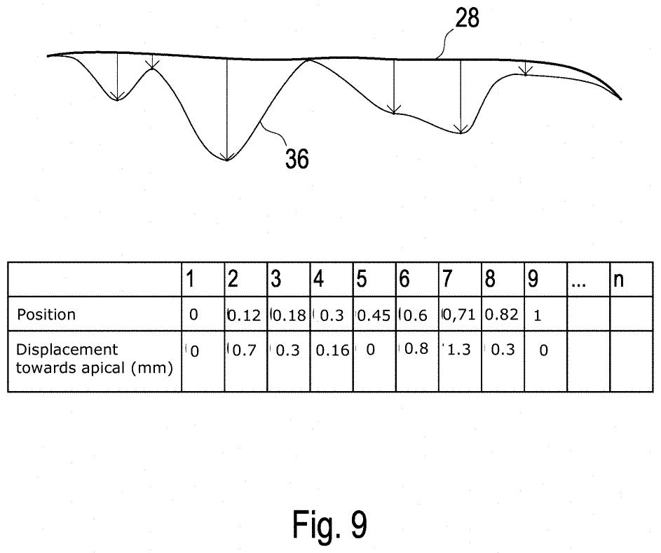

A number of node points (FIG. 9) is defined on the surface contour. As an example, said nodes are designated with node 1 to node 9 and are listed in a table in FIG. 9. As illustrated by arrows, the node points located on the first surface contour 28 are displaced in apical direction. Connecting the displaced nodes results in the second surface contour 36.

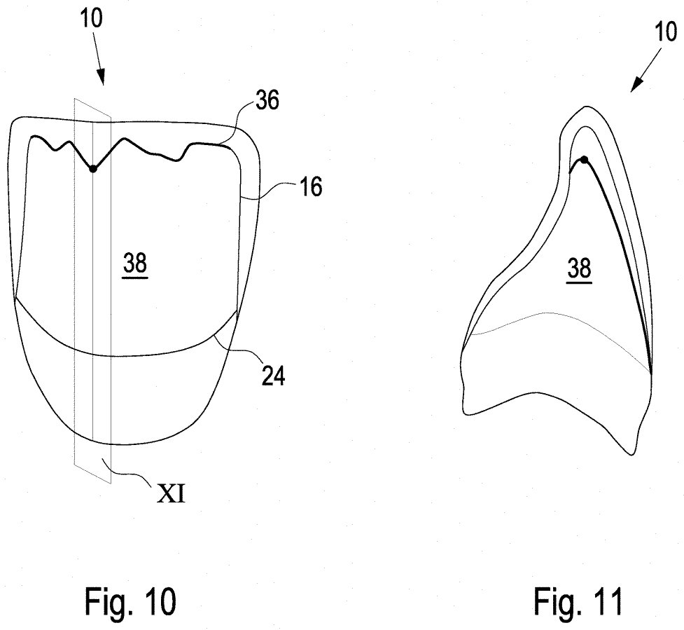

The aforementioned method steps then result in a three-dimensional boundary surface in the illustrated exemplary embodiment, which is defined by the third boundary curve 24, parts of the first boundary surface 16, and the second surface contour 36 (FIGS. 10 and 11). Within this three-dimensional surface, i.e. in the space 38, a different material is provided in a preferred embodiment according to the disclosure than in the volumes of the artificial tooth element 10 surrounding said space. These two volumes are defined in particular by different materials, with the inner volume 38 reproducing the tooth enamel. Here, the boundary surface between the volume forming the tooth enamel and the surrounding volume is not identical to the corresponding boundary surface of the associated natural tooth.

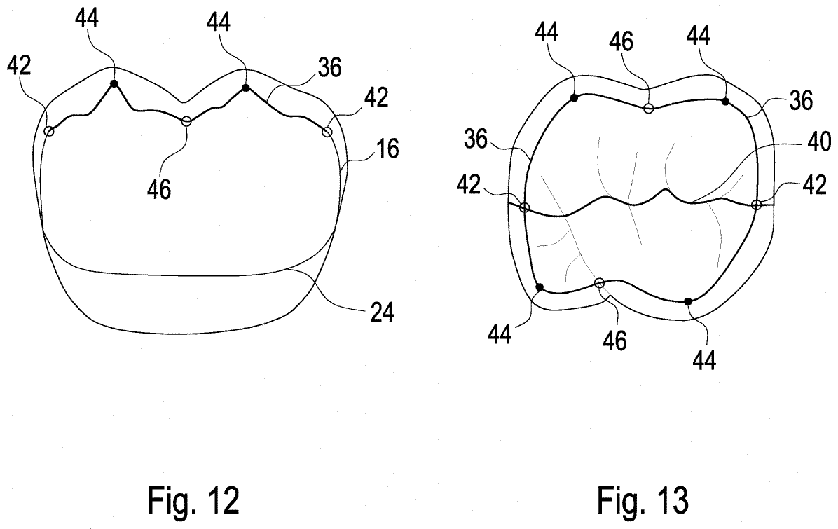

FIGS. 12 and 13 show the corresponding contours for a posterior tooth, wherein said contour correspond to the contours described for the protruding edge of an anterior tooth. In addition, the central fissure 40 (FIG. 13) is shown. The line illustrating the central fissure 40 has two boundary points 42 which respectively represent the cusp start or the cusp end, respectively. Furthermore, cusp tips 44 are marked on the second surface contour 36. A point 46 designates a cusp end and cusp start of the next cusp.

1. A method for defining at least one boundary surface inside a digital tooth data model of an artificial tooth element, comprising at least the following steps:
defining a first boundary curve on the tooth surface of the artificial tooth element,
determining, with respect to the first boundary curve, an incisally/occlusally located tooth surface, and
displacing said tooth surface inwards in the direction of the surface normal by different amounts in order to produce the at least one boundary surface,
wherein the different amounts of displacement are based on variable design parameters.

2. The method according to claim 1, wherein the tooth surface is divided into a plurality of partial surfaces.

3. The method according to claim 2, wherein the partial surfaces are displaced in the direction of the associated surface normal by different amounts in order to produce the at least one boundary surface.

4. The method according to claim 3, wherein the partial surfaces are displaced in order to form an in particular reduced closed boundary surface (16).

5. The method according to claim 1, wherein the variable design parameters describe a maximum first displacement of the tooth surface and a first length for defining a transition surface,
wherein in the case of a first displacement there is no displacement yet for anterior and posterior teeth directly at the first boundary curve and for posterior teeth additionally at the central fissure, and
wherein the amount of the first displacement in the direction of the surface normal towards incisal/occlusal from the first boundary curve increases steadily until the maximum first displacement is reached, the first length being specified as a design parameter.

6. The method according to claim 5, wherein the transition surface extends in incisal/occlusal direction.

7. The method according to claim 5, wherein the transition surface is formed adjacent to the first boundary curve.

8. The method according to claim 1, wherein the first boundary surface is projected by the first length towards incisal/occlusal for defining a second boundary curve, and
wherein the transition surface is defined between the first and the second boundary curve.

9. The method according to claim 1, wherein the variable design parameters describe a displacement of the first boundary surface, in which a third boundary curve is defined by projection of the first or second boundary curve by a second length, and
an incisal/occlusal first surface contour is determined as the highest curve on the first boundary surface produced by the first maximum displacement,
on which node points are created, the position of which is defined on the first surface contour, and
wherein a second surface contour is produced by at least partially displacing the node points in apical and/or incisal/occlusal direction and by connecting the at least partially displaced node points,
which defines the maximum second displacement of the first boundary surface in the area of the incisal/occlusal surface contour, and
wherein the amount of the second displacement in the direction of the surface normal decreases steadily by a third length for anterior and posterior teeth in apical direction and for posterior teeth also in the direction of the central fissure until at most the third boundary curve or the central fissure, respectively, is reached.

10. The method according to claim 5, wherein the maximum first displacement of the determined tooth surface is about 0 to 4.0 mm and/or wherein the first length has an extension of 0.1 to 10.0 mm.

11. The method according to claim 9, wherein for anterior teeth a boundary of the highest curve on the first and/or second incisal/occlusal surface contour is determined by an angle of the tangent on the incisal surface contour (28, 36) in relation to the tooth axis, the angle being 0° to 90°.

12. The method according to claim 9, wherein the beginning, end and course of the incisal surface contour is manually defined or adjusted.

13. The method according to claim 9, wherein the positions of the node points on the incisal surface contour of anterior teeth are specified relative to the total length of the incisal surface contour.

14. The method according to claim 9, wherein the positions of the node points on the incisal/occlusal surface contour of posterior teeth are specified per cusp relative to the lengths of the cusp ridges between the mesial cusp start and the cusp tip or the cusp tip and the distal cusp end, respectively.

15. The method according to claim 9, wherein the displacement of the node points on the incisal/occlusal surface contour in apical direction is in the range of −4.0 mm to +4.0 mm.

16. The method according to claim 1, wherein the tooth element is aligned with respect to the anatomically defined directional terms by geometric analysis of the tooth elements and their comparison to reference geometries.

17. The method according to claim 1, wherein the alignment of the tooth element is based on metadata which were generated when producing the outer contour, and/or wherein the tooth element is aligned manually.

18. The method according to claim 1, wherein the first boundary curve is based on detecting the tooth equator as a curve on which at least four node points are described according to the anatomically defined directional terms, which node points are displaced in apical or incisal/occlusal direction by distances defined relative to the tooth size on the tooth surface, and/or wherein the first boundary curve is based on detecting the preparation boundary as a curve on which at least four node points are described according to the anatomically defined directional terms, which node points are displaced in apical or incisal/occlusal direction by distances defined relative to the tooth size or with regard to the distance to the preparation boundary on the tooth surface.

19. The method according to claim 1, wherein the central fissure is determined automatically for posterior teeth by detecting the deepest curve on the occlusal surface leading from mesial to distal.

20. The method according to claim 1, wherein the first and/or second and/or third boundary curve is manually defined or adjusted, and/or wherein the central fissure for posterior teeth is manually defined or adjusted.

21. The method according to claim 1, wherein any layers can be adjusted manually by virtual modelling tools.
